(19) United States
(12) Patent Application Publication
(10) Pub. No.: US 2023/0387476 A1
(43) Pub. Date: Nov. 30, 2023

(54) NON-AQUEOUS RECHARGEABLE BATTERY, ELECTRODE PLATE FOR NON-AQUEOUS RECHARGEABLE BATTERY, AND METHOD FOR MANUFACTURING NON-AQUEOUS RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Junya HISHII, Kosai-shi (JP); Hiroaki IKEDA, Toyota-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/203,032

(22) Filed: May 29, 2023

(30) Foreign Application Priority Data
May 31, 2022 (JP) 2022-088739

(51) Int. Cl. H01M 10/0587; H01M 50/103; H01M 4/13; H01M 50/538; H01M 10/0569; H01M 4/04; H01M 10/44; H01M 50/609; H01M 10/0525; H01M 10/04

(52) U.S. Cl. CPC H01M 10/0587; H01M 50/103; H01M 4/13; H01M 50/538; H01M 10/0569; H01M 4/0404; H01M 10/446; H01M 50/609; H01M 10/0525; H01M 10/0431; H01M 2004/028

(57) ABSTRACT

A non-aqueous rechargeable battery includes an electrode body, a non-aqueous electrolyte solution, and a battery case. The electrode body includes a negative electrode plate, a positive electrode plate, and a separator arranged between the negative and positive electrode plates. The battery case accommodates the electrode body and the non-aqueous electrolyte solution. The positive electrode plate includes a positive electrode substrate and a positive electrode mixture layer arranged on the positive electrode substrate. The positive electrode mixture layer is formed by applying a positive electrode mixture paste, containing at least a positive electrode active material and an organic solvent, to the positive electrode substrate and drying the positive electrode mixture paste so that the organic solvent remains in the positive electrode mixture layer. The non-aqueous rechargeable battery is charged in a state in which the electrode body and the non-aqueous electrolyte solution are accommodated in the battery case.

### BACKGROUND

### 1. Field

The following description relates to a non-aqueous rechargeable battery, an electrode plate for a non-aqueous rechargeable battery, and a method for manufacturing a non-aqueous rechargeable battery, and more specifically to a non-aqueous rechargeable battery, an electrode plate for a non-aqueous rechargeable battery, and a method for manufacturing a non-aqueous rechargeable battery that limit performance deterioration.

### 2. Description of Related Art

Japanese Laid-Open Patent Publication No. 2015-099725 describes an example of a non-aqueous rechargeable battery including an electrode body formed by stacking a negative electrode plate, a positive electrode plate, and a separator in a stacking direction and rolling the stack in a rolling direction. The rolled electrode body is accommodated in a battery case together with a non-aqueous electrolyte solution.

Repeated charging and discharging of the non-aqueous rechargeable battery described in Japanese Laid-Open Patent Publication No. 2015-099725 will increase DC internal resistance in the electrode body. This may result in, for example, performance deterioration such as deterioration of the high rate characteristics.

### SUMMARY

In one aspect, a non-aqueous rechargeable battery includes an electrode body, a non-aqueous electrolyte solution, and a battery case. The electrode body includes a negative electrode plate, a positive electrode plate, and a separator arranged between the negative electrode plate and the positive electrode plate. The battery case accommodates the electrode body and the non-aqueous electrolyte solution. The positive electrode plate includes a positive electrode substrate and a positive electrode mixture layer arranged on the positive electrode substrate. The positive electrode mixture layer is formed by applying a positive electrode mixture paste, containing at least a positive electrode active material and an organic solvent, to the positive electrode substrate and drying the positive electrode mixture paste so that the organic solvent remains in the positive electrode mixture layer. The non-aqueous rechargeable battery is charged in a state in which the electrode body and the non-aqueous electrolyte solution are accommodated in the battery case.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In the non-aqueous rechargeable battery, in a state in which the positive electrode plate, the negative electrode plate, and the separator are stacked in a stacking direction, the electrode body is rolled in a longitudinal direction intersecting the stacking direction. The positive electrode mixture layer is formed so that a larger amount of the organic solvent remains in an end region with respect to a widthwise direction, intersecting the stacking direction and the longitudinal direction, than in a middle region with respect to the widthwise direction.

In the non-aqueous rechargeable battery, when the non-aqueous rechargeable battery is charged, the organic solvent vaporizes and forms bubbles. The end region is separated from an end of the positive electrode mixture layer in the widthwise direction by a distance that is less than or equal to a radius of the bubbles.

In the non-aqueous rechargeable battery, the organic solvent is N-methylpyrrolidone.

A further aspect is an electrode plate for a non-aqueous rechargeable battery. The electrode plate includes an electrode substrate and a mixture layer arranged on the electrode substrate. The mixture layer is formed by applying a mixture paste, containing at least an active material and an organic solvent, to the electrode substrate and drying the mixture paste so that the organic solvent remains in the mixture layer.

In the electrode plate, the mixture layer is formed so that a larger amount of the organic solvent remains in an end region with respect to a widthwise direction than in a middle region with respect to the widthwise direction.

Another aspect is a method for manufacturing a non-aqueous rechargeable battery. The non-aqueous rechargeable battery includes an electrode body, a non-aqueous electrolyte solution, and a battery case accommodating the electrode body and the non-aqueous electrolyte solution. The electrode body includes a negative electrode plate, a positive electrode plate, and a separator arranged between the negative electrode plate and the positive electrode plate. The method includes applying a positive electrode mixture paste, containing at least a positive electrode active material and an organic solvent, to a positive electrode substrate, forming a positive electrode mixture layer by drying the positive electrode mixture paste so that the organic solvent remains in the positive electrode mixture layer, and charging the non-aqueous rechargeable battery in a state in which the electrode body and the non-aqueous electrolyte solution are accommodated in the battery case.

Other features and aspects will be apparent from the following detailed description, the drawings, and the claims.

### BRIEF DESCRIPTION OF THE DRAWINGS

FIG. 1 is a perspective view showing one embodiment of a lithium-ion rechargeable battery.

FIG. 2 is a schematic diagram showing a stack of an electrode body in the lithium-ion rechargeable battery.

FIG. 3 is a flowchart illustrating a process for manufacturing the lithium-ion rechargeable battery.

FIG. 4 is a schematic diagram of a positive electrode plate as viewed in a longitudinal direction Z during a drying step.

FIG. 5 is a schematic diagram of the positive electrode plate as viewed in the longitudinal direction Z during a slitting step.

FIG. 6 is a chart illustrating the relationship of the internal pressure of a battery case, number of charge-discharge cycles, and the DC internal resistance increase rate.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art

### First Embodiment

One embodiment of a rechargeable battery will now be described.

Lithium-Ion Rechargeable Battery 10

The structure of a lithium-ion rechargeable battery will now be described.

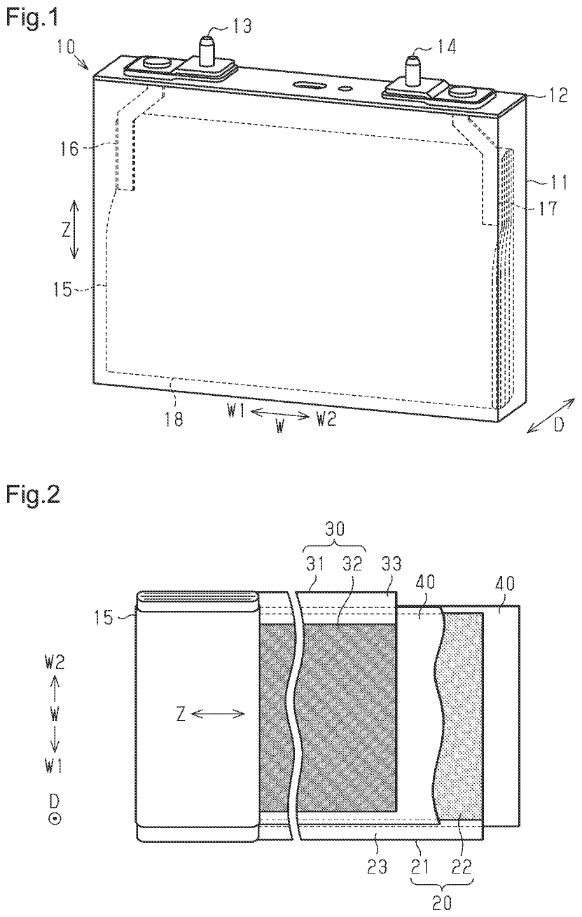

As shown in FIG. 1, the lithium-ion rechargeable battery 10 is formed as a cell. The lithium-ion rechargeable battery 10 includes a battery case 11. The battery case 11 includes a lid 12. The battery case 11 includes an open upper end. The lid 12 closes the open upper end. The battery case 11 is formed from a metal such as an aluminum alloy. The lid 12 includes a negative electrode external terminal 13 and a positive electrode external terminal 14 that are used when charging and discharging the lithium-ion rechargeable battery 10. The negative electrode external terminal 13 and the positive electrode external terminal 14 may have any shape.

The lithium-ion rechargeable battery 10 includes an electrode body 15. The lithium-ion rechargeable battery 10 includes a negative electrode collector 16 and a positive electrode collector 17. The negative electrode collector 16 connects the negative electrode of the electrode body 15 to the negative electrode external terminal 13. The positive electrode collector 17 connects the positive electrode of the electrode body 15 to the positive electrode external terminal 14. The electrode body 15 is accommodated in the battery case 11.

The lithium-ion rechargeable battery 10 includes a non-aqueous electrolyte solution 18. The battery case 11 is filled with the non-aqueous electrolyte solution 18 through a liquid inlet (not shown). Attachment of the lid 12 to the open upper end of the battery case 11 forms a sealed battery jar of the lithium-ion rechargeable battery 10. In this manner, the battery case 11 accommodates the electrode body 15 and the non-aqueous electrolyte solution 18.

Non-Aqueous Electrolyte Solution 18

The non-aqueous electrolyte solution 18 is a composition containing support salt in a non-aqueous solvent. In the present embodiment, ethylene carbonate (EC) is used as the non-aqueous solvent. The non-aqueous solvent may be one or more selected from a group consisting of propylene carbonate (PC), diethyl carbonate (DEC), dimethyl carbonate (DMC), ethyl methyl carbonate (EMC), and the like.

The support salt may be LiPF₆, LiBF₄, LiClO₄, LiAsF₆, LiCF₃SO₃, LiC₄F₉SO₃, LiN(CF₃SO₂)₂, LiC(CF₃SO₂)₃, LiI, or the like. Further, the support salt may be a lithium compound (lithium salt) of one or more selected from these substances. In this manner, the non-aqueous electrolyte solution 18 includes a lithium compound.

Electrode Body 15

As shown in FIG. 2, the electrode body 15 includes a negative electrode plate 20, a positive electrode plate 30, and separators 40. The longitudinal direction of the electrode body 15 is referred to as the longitudinal direction Z. The thickness direction of the electrode body 15 is referred to as the thickness direction D. The direction intersecting the longitudinal direction Z and the thickness direction D of the electrode body 15 is referred to as the widthwise direction W. The direction toward one side in the widthwise direction W is referred to as the first widthwise direction W1, and the direction toward the other side in the widthwise direction W is referred to as the second widthwise direction W2. The second widthwise direction W2 is opposite the first widthwise direction W1.

The electrode body 15 is formed by stacking the negative electrode plate 20, the positive electrode plate 30, and the separators 40 in the thickness direction D. The separators 40 are stacked between the negative electrode plate 20 and the positive electrode plate 30 in the electrode body 15. More specifically, the separator 40, the positive electrode plate 30, the separator 40, and the negative electrode plate 20 are stacked in this order in the electrode body 15.

The negative electrode plate 20, the positive electrode plate 30, and the separators are stacked in the thickness direction D and then rolled in the longitudinal direction Z to form the electrode body 15. The electrode body 15 is flattened in the thickness direction D at the middle part with respect to the longitudinal direction Z.

The negative electrode plate 20, the positive electrode plate 30, and the separators are stacked in this manner in the thickness direction D, also referred to as the stacking direction. Further, the negative electrode plate 20, the positive electrode plate 30, and the separators 40 are rolled in the longitudinal direction Z, also referred to as the rolling direction.

Negative Electrode Plate 20

The negative electrode plate 20 functions as one example of a negative electrode of the lithium-ion rechargeable battery 10. The negative electrode plate 20 includes a negative electrode substrate 21 and negative electrode mixture layers 22. The negative electrode mixture layers 22 are arranged on the two opposite sides of the negative electrode substrate 21.

The negative electrode substrate 21 includes a negative electrode connector 23. The negative electrode connector 23 is a region in the two sides of the negative electrode substrate 21 that is free from the negative electrode mixture layers 22. The negative electrode connector 23 is arranged at one end of the electrode body 15 in the first widthwise direction W1. The negative electrode connector 23 is exposed from the separator 40 in the first widthwise direction W1.

In the present embodiment, the negative electrode substrate 21 is formed by a Cu foil. The negative electrode substrate 21 serves as a base for the aggregate of the negative electrode mixture layer 22. The negative electrode substrate 21 has the functionality of a collector that collects electric current from the negative electrode mixture layer 22.

The negative electrode mixture layer 22 includes a negative electrode active material. In the present embodiment, the negative electrode active material, which allows for the storage and release of lithium ions, is a powdered carbon material of graphite or the like.

The negative electrode plate 20 is formed by, for example, kneading a negative electrode active material, a solvent, and a binder and then drying the kneaded negative electrode mixture paste in a state applied to the negative electrode substrate 21. In other words, the negative electrode mixture layer 22 is formed by applying the negative electrode mixture paste, which contains at least a negative electrode active material and a solvent, to the negative electrode substrate 21 and drying the negative electrode mixture paste. The solvent of the negative electrode mixture layer 22 is, for example, water, which can be replaced by an organic solvent (non-aqueous solvent).

Positive Electrode Plate 30

The positive electrode plate 30 functions as one example of a positive electrode of the lithium-ion rechargeable battery 10. The positive electrode plate 30 includes a positive electrode substrate 31 and positive electrode mixture layers 32. The positive electrode mixture layer 32 are arranged on the two opposite sides of the positive electrode substrate 31.

The positive electrode substrate 31 includes a positive electrode connector 33. The positive electrode connector 33 is a region in the two sides of the positive electrode substrate 31 that is free from the positive electrode mixture layers 32. The positive electrode connector 33 is arranged at one end of the electrode body 15 in the second widthwise direction W2. The positive electrode connector 33 is exposed from the separator 40 in the second widthwise direction W2.

In the present embodiment, the positive electrode substrate 31 is formed by an Al foil or an Al alloy foil. The positive electrode substrate 31 serves as a base for the aggregate of the positive electrode mixture layer 32. The positive electrode substrate 31 has the functionality of a collector that collects electric current from the positive electrode mixture layer 32.

The positive electrode mixture layer 32 includes a positive electrode active material. The positive electrode active material, which allows for the storage and release of lithium, is, for example, lithium cobalt oxide (LiCoO₂), lithium manganese oxide (LiMn₂O₄), lithium nickel oxide (LiNiO₂), or the like. Further, the positive electrode active material may be obtained by mixing LiCoO₂, LiMn₂O₄, and LiNiO₂ at a given ratio. The positive electrode mixture layer 32 includes a conductive material. The conductive material may be, for example, graphite or carbon black, such as acetylene black (AB) or ketjen black.

The positive electrode plate 30 is formed by, for example, kneading a positive electrode active material, a conductive material, a solvent, and a binder and then drying the kneaded positive electrode mixture paste in a state applied to the positive electrode substrate 31. In other words, the positive electrode mixture layer 32 is formed by applying the positive electrode mixture paste, which contains at least a positive electrode active material and a non-aqueous solvent, to the positive electrode substrate 31 and drying the positive electrode mixture paste. The solvent of the positive electrode mixture layer 32 is, for example, N-methylpyrrolidone (NMP) such as N-methyl-2-pyrrolidone, which can be replaced by another organic solvent (non-aqueous solvent).

Separator 40

The separators 40 are arranged between the negative electrode plate 20 and the positive electrode plate 30. The separator 40 holds the non-aqueous electrolyte solution 18. Each separator 40 is a nonwoven fabric of polypropylene, which is a porous resin, or the like. The separator 40 may be a porous polymer film, such as a porous polyethylene film, a porous polyolefin film, or a porous polyvinyl chloride film. Alternatively, the separator 40 may be a lithium ion or ion conductive polymer electrolyte film. As another option, the separator 40 may be a combination of such films Immersion of the electrode body 15 in the non-aqueous electrolyte solution 18 results in the non-aqueous electrolyte solution 18 permeating the separators 40 from the ends toward the middle part.

Manufacturing Process of Lithium-Ion Rechargeable Battery 10

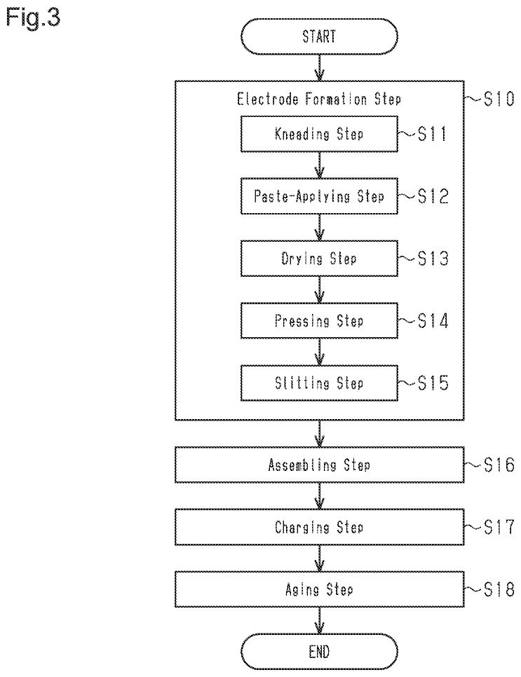

The manufacturing process of the lithium-ion rechargeable battery 10 will now be described with reference to FIG. 3. The manufacturing process of the lithium-ion rechargeable battery 10 includes steps S10 to S18. That is, the method for manufacturing the lithium-ion rechargeable battery 10 includes steps S10 to S18.

As shown in FIG. 3, step S10 is an electrode formation step. The electrode formation step forms the elements of the lithium-ion rechargeable battery 10. More specifically, the electrode formation step forms the negative electrode plate 20 and the positive electrode plate 30 that are the elements of the lithium-ion rechargeable battery 10.

In detail, the electrode formation step includes kneading, paste-applying, drying, pressing, and slitting. The electrode formation step begins from kneading in step S11. The kneading step includes kneading a positive electrode mixture paste and kneading a negative electrode mixture paste.

After the kneading step, paste-applying is performed in step S12. The paste-applying step applies a negative electrode mixture paste to the two sides of the negative electrode substrate 21 to form the negative electrode connector 23 at the two ends in the widthwise direction W. Further, the paste-applying step applies a positive electrode mixture paste to the two sides of the positive electrode substrate 31 to form the positive electrode connector 33 at the two ends in the widthwise direction W.

After the paste-applying step, drying is performed in step S13. The drying step dries the negative electrode mixture paste applied to the negative electrode substrate 21 to form the negative electrode mixture layer 22. Further, the drying step dries the positive electrode mixture paste applied to the positive electrode substrate 31 to form the positive electrode mixture layer 32.

After the drying step, pressing is performed in step S14. The pressing step presses the negative electrode mixture layer 22 formed on each of the two sides of the negative electrode substrate 21 to adjust the thickness of the negative electrode mixture layer 22. Further, the pressing step presses the positive electrode mixture layer 32 formed on each of the two sides of the positive electrode substrate 31 to adjust the thickness of the positive electrode mixture layer 32.

After the pressing step, slitting is performed in step S15. The slitting step slits the middle of the negative electrode plate 20 with respect to the widthwise direction W. This step obtains two negative electrode plates 20. Further, the slitting step slits the middle of the positive electrode plate 30 in the widthwise direction W. This step obtains two positive electrode plates 30.

Subsequent to the electrode formation step, assembling is performed in step S16. In the assembling step, the lithium-ion rechargeable battery 10 is assembled. In the assembling step, the electrode body 15 is first manufactured. More specifically, the positive electrode plate 30 and the negative electrode plate 20 is stacked with the separator 40 located in between. Then, the stack is rolled and pressed into a flattened roll. Afterwards, the negative electrode connector 23 is pressed, and the positive electrode connector 33 is pressed. The procedures described above manufactures the electrode body 15.

Then, the electrode body 15 is arranged in the battery case 11. In this example, the positive electrode connector 33 is electrically connected by the positive electrode collector 17 to the positive electrode external terminal 14. Further, the negative electrode connector 23 is electrically connected by the negative electrode collector 16 to the negative electrode external terminal 13. The open end of the battery case 11 is closed by the lid 12. Further, the battery case 11 is filled with the non-aqueous electrolyte solution 18. After filling the battery case 11 with the non-aqueous electrolyte solution 18, the battery case 11 is sealed. The procedures described above assembles the lithium-ion rechargeable battery 10.

After the assembling step, charging is performed in step S17. The charging step charges the lithium-ion rechargeable battery 10 assembled in the assembling step. The charging performed in the charging step is initial charging of the lithium-ion rechargeable battery 10 assembled in the assembling step.

After the charging step, aging is performed in step S18. The aging step leaves the lithium-ion rechargeable battery 10, which has undergone the charging step, to stand for a certain period under a high temperature. The aging step melts the metal foreign material in the lithium-ion rechargeable battery 10 and stabilizes a solid electrolyte interphase (SEI) film.

Drying Step of Lithium-Ion Rechargeable Battery 10

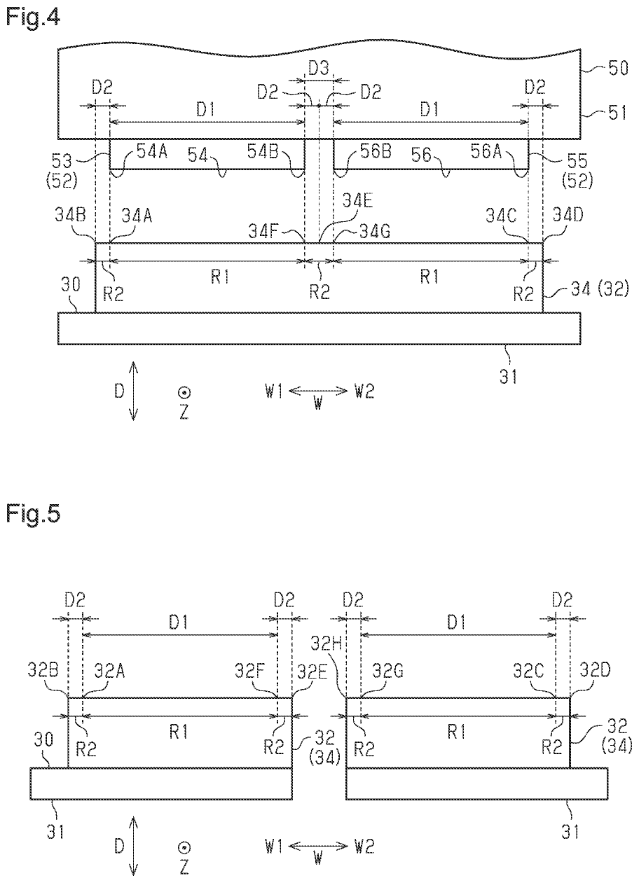

With reference to FIGS. 4 and 5, the drying step of the lithium-ion rechargeable battery 10 will now be described. FIGS. 4 and 5 show a state in which a positive electrode mixture paste 34 is applied to one side of the positive electrode substrate 31.

As shown in FIG. 4, in the drying step, the positive electrode mixture paste 34, which is applied to the positive electrode substrate 31 is dried by a drying device 50. The drying device 50 dries the positive electrode mixture paste 34, which is applied to the positive electrode substrate 31.

The drying device 50 includes a main body 51 and drying nozzles 52. The drying nozzles 52 are arranged on the main body 51. The drying nozzles 52 are used to dry the positive electrode mixture paste applied to the positive electrode substrate 31.

The drying nozzles 52 include a first drying nozzle 53. The first drying nozzle 53 includes a first drying nozzle surface 54. The first drying nozzle surface 54 is arranged to face the positive electrode mixture paste 34 applied to the positive electrode substrate 31. Hot air is blown from the first drying nozzle surface 54 toward the positive electrode plate to dry the positive electrode mixture paste 34 applied to the positive electrode substrate 31.

The first drying nozzle surface 54 includes a first end 54A in the first widthwise direction W1 and a second end 54B in the second widthwise direction W2. The first drying nozzle surface 54 extends over distance D1 in the widthwise direction W. Thus, the first drying nozzle surface 54 is sized so that the first end 54A and the second end 54B are separated by distance D1 in the widthwise direction W.

The first drying nozzle surface 54 is arranged so that the first end 54A opposes a first position 34A in the thickness direction D. The first position 34A is separated by distance D2 in the second widthwise direction W2 from an end 34B of the positive electrode mixture paste 34 in the first widthwise direction W1. The distance D1 is approximately thirteen times greater than distance D2 although this is not a limitation. In one specific example, distance D1 is 40 mm, and distance D2 is 3 mm.

The drying nozzles 52 include a second drying nozzle 55. The second drying nozzle includes a second drying nozzle surface 56. The second drying nozzle surface 56 is arranged to face the positive electrode mixture paste 34 applied to the positive electrode substrate 31. Hot air is blown from the second drying nozzle surface 56 toward the positive electrode plate 30 to dry the positive electrode mixture paste 34 applied to the positive electrode substrate 31.

The second drying nozzle surface 56 includes a first end 56A in the second widthwise direction W2 and a second end 56B in the first widthwise direction W1. The second drying nozzle surface 56 extends over distance D1 in the widthwise direction W. Thus, the second drying nozzle surface 56 is sized so that the first end 56A and the second end 56B are separated by distance D1 in the widthwise direction W.

The second drying nozzle surface 56 is arranged so that the first end 56A opposes a second position 34c in the thickness direction D. The second position 34c is separated by distance D2 in the first widthwise direction W1 from an end 34D of the positive electrode mixture paste 34 in the second widthwise direction W2.

The first drying nozzle 53 and the second drying nozzle 55 are arranged next to each other in the widthwise direction W of the positive electrode plate 30. The first drying nozzle 53 is located toward the first widthwise direction W1 from the second drying nozzle 55. The first drying nozzle surface 54 is separated from the second drying nozzle surface 56 by distance D3. Thus, the second end 54B of the first drying nozzle surface 54 is separated by distance D3 from the second end 56B of the second drying nozzle surface 56.

Distance D3 is, for example, two times greater than distance D2. In one specific example, distance D3 is 6 mm. The second end 54B of the first drying nozzle surface 54 opposes, in the thickness direction D, a position on the positive electrode mixture paste 34 separated by distance D2 in the first widthwise direction W1 from a center position 34E of the positive electrode mixture paste 34. The second end 56B of the second drying nozzle surface 56 opposes, in the thickness direction D, a position on the positive electrode mixture paste 34 separated by distance D2 in the second widthwise direction W2 from the center position 34E of the positive electrode mixture paste 34.

In this manner, the first drying nozzle surface 54 is arranged so that the second end 54B opposes a third position 34F in the thickness direction D. The third position 34F is separated by distance D2 in the first widthwise direction W1 from the center position 34E of the positive electrode mixture paste 34.

Further, the second drying nozzle surface 56 is arranged so that the second end 56B opposes a fourth position 34G in the thickness direction D. The fourth position 34G is separated by distance D2 in the second widthwise direction W2 from the center position 34E of the positive electrode mixture paste 34.

In this manner, the positive electrode mixture paste 34 is dried by blowing air from the drying nozzles 52. The positive electrode mixture paste 34 includes first regions R1 that face the drying nozzles 52 in the thickness direction D and second regions R2 that do not face the drying nozzles 52 and are less heated than the first regions R1. Thus, the organic solvent contained in the positive electrode mixture paste 34 is less heated in the second regions R2 than in the first regions R1. Accordingly, the organic solvent contained in the positive electrode mixture paste 34 is less vaporized in the second regions R2 than in the first regions R1. Consequently, a larger amount of organic solvent remains in the positive electrode mixture layer 32 at the second regions R2 than in the first regions R1.

In one specific example, in the second regions R2, the amount of organic solvent remaining in the positive electrode mixture layer 32 is 1000 to 1200 ppm. In the first regions R1, the amount of organic solvent remaining in the positive electrode mixture layer 32 is 450 ppm or less. Further, the average amount of the organic solvent remaining in the combined first regions R1 and the second regions R2 of the positive electrode mixture layer 32 is 550 ppm or less.

In the present embodiment, the negative electrode plate 20 and the positive electrode plate 30 are dried differently. More specifically, hot air is uniformly blown toward the entire negative electrode plate 20 to dry the negative electrode mixture paste applied to the negative electrode substrate 21.

Referring to FIG. 5, the positive electrode mixture layer 32 is formed by drying the positive electrode mixture paste 34. In FIG. 5, reference characters 32A to 32G added to the positive electrode mixture layer 32 respectively correspond to reference characters 34A to 34G added to the positive electrode mixture paste 34. The first regions R1 and the second regions R2 are located at the same areas in the positive electrode mixture paste 34 and the positive electrode mixture layer 32.

The positive electrode plate 30 is slit in the slitting step at a center position 32E of the positive electrode mixture layer 32. This forms two positive electrode plates 30, each having a first region R1 in a middle portion with respect to the widthwise direction W and second regions R2 at the two ends with respect to the widthwise direction W.

In detail, in each of the two positive electrode plates 30, the first region R1 is the region located at the middle of the positive electrode mixture layer 32 with respect to the widthwise direction W. Further, in each of the two positive electrode plates 30, the second regions R2 are the regions located at the two ends of the positive electrode mixture layer 32 with respect to the widthwise direction W. In particular, in each of the two positive electrode plates 30, the second regions R2 are the end regions extending from the two ends in the widthwise direction W to positions that are separated by distance D2. That is, the second regions R2 extend over distance D2 from the two ends in the widthwise direction W toward the middle of the positive electrode plate 30.

In each positive electrode plate 30, which was slit in the slitting step, more organic solvent remains in the end regions of the positive electrode mixture layer 32 with respect to the widthwise direction W than in the middle region of the positive electrode mixture layer 32 with respect to the widthwise direction W. In other words, in each positive electrode plate 30, which was slit in the slitting step, less organic solvent remains in the middle region of the positive electrode mixture layer 32 with respect to the widthwise direction W than the end regions of the positive electrode mixture layer 32 with respect to the widthwise direction W.

The positive electrode plate 30 manufactured in such a manner is used in the electrode body 15. The electrode body 15 is accommodated in the battery case 11. The battery case 11 is sealed in a state filled with the non-aqueous electrolyte solution 18. The lithium-ion rechargeable battery 10 manufactured in this manner is charged in the charging step. In the charging step, the organic solvent remaining as the positive electrode mixture layer 32 is vaporized by, for example, chemical decomposition, heating, and the like. In this manner, the organic solvent remaining in the positive electrode mixture layer 32 vaporizes in the battery case 11. This increases the internal temperature of the battery case 11.

In particular, the second regions R2 correspond to the end regions of the positive electrode mixture layer 32. Thus, the bubbles formed when the organic solvent in the positive electrode mixture layer 32 vaporizes are readily discharged out of the electrode body 15 from the ends of the electrode body 15 and do not remain in the electrode body 15.

Preferably, distance D2 is less than or equal to the radius of the bubbles formed when the organic solvent vaporizes. In one specific example, when the bubble radius is 6 mm, distance D2 is preferably 3 mm or less. Consequently, the bubbles formed when the organic solvent in the positive electrode mixture layer 32 vaporizes are readily discharged out of the electrode body 15 from the ends of the electrode body 15 and do not remain in the electrode body 15.

### Example

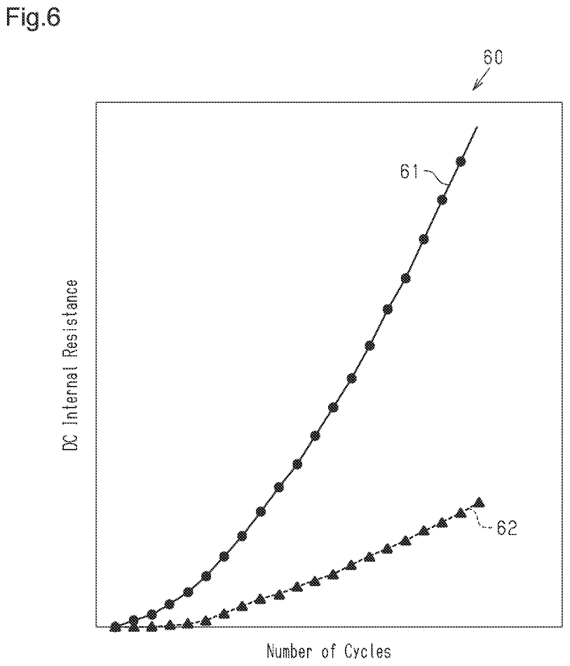

With reference to FIG. 6, an example of the lithium-ion rechargeable battery 10 will now be described. The relationship of the internal pressure of the battery case 11, the number of charge-discharge cycles, and the DC internal increase rate will be described in this example.

In graph 60 of FIG. 6, the vertical axis represents the DC internal resistance increase rate and the horizontal axis represents the number of charge-discharge cycles. Graph 60 includes a first curve 61 and a second curve 62. The internal pressure of the battery case 11 is higher in the second curve 62 than the first curve 61.

The DC internal resistance increase rate when the number of charge-discharge cycles increases is more limited when the internal pressure of the battery case 11 is high than when the internal pressure of the battery case 11 is low. As long as the number of charge-discharge cycles is within an expected range, the number of charge-discharge cycles is substantially proportional to the DC internal resistance in the first curve 61 and the second curve 62.

In one specific example, if the internal pressure of the battery case 11 is increased twofold, the DC internal resistance increase rate is decreased by 15% when the number of cycles is 400. In other words, when the internal pressure of the battery case 11 is increased twofold, the number of cycles for raising the DC internal resistance by 5% changes from 200 times to 400 times.

Further, the internal pressure of the battery case 11 in the present embodiment is 1.2 times greater than that of the prior art. This decreases the DC internal resistance by 1.5% when the number of cycles becomes 400. In other words, when compared with the prior art, the present embodiment increases the internal pressure of the battery case 11 by 1.2 times and increases the number of cycles for raising the DC internal resistance 5% by 1.2 times.

### Operation of Present Embodiment

The operation of the present embodiment will now be described.

As shown in FIG. 4, in the electrode formation step, the kneaded positive electrode mixture paste 34 is applied to the two sides of the positive electrode substrate 31. Further, the positive electrode mixture paste 34 is dried so that the second regions R2 are less heated than the first regions R1. Thus, less organic solvent is vaporized in the second regions R2 than the first regions R1. This forms the positive electrode mixture layer 32 so that organic solvent remains in the second regions R2.

The positive electrode plate 30 manufactured in such a manner is accommodated as the electrode body 15, together with the non-aqueous electrolyte solution 18, in the battery case 11. Then, the lithium-ion rechargeable battery 10 is charged to vaporize the organic solvent remaining in the positive electrode mixture layer 32 and increase the internal pressure of the battery case 11.

In the prior art, charging and discharging of the lithium-ion rechargeable battery 10 will result in the concentration of the support salt in the non-aqueous electrolyte solution 18 becoming higher at the positive electrode plate 30 than the negative electrode plate 20. Thus, the concentration of the support salt will become biased in the thickness direction D of the electrode body 15. This tendency becomes particularly outstanding when high rate charging and discharging is performed.

Further, repetitive charging and discharging of the lithium-ion rechargeable battery 10 repetitively expands and contracts the electrode body 15. This forces the non-aqueous electrolyte solution 18, at the portion where the concentration of the support salt is low, out of the electrode body 15. As a result, the concentration of the support salt will be biased at the middle and the ends of the electrode body 15 with respect to the widthwise direction W. Thus, the DC internal resistance becomes high in the electrode body 15. This may result in performance deterioration of the lithium-ion rechargeable battery 10, for example, deterioration of the high rate characteristics.

To resolve this shortcoming, organic solvent is intentionally left in the positive electrode mixture layer 32 so that the organic solvent remaining in the positive electrode mixture layer 32 can be vaporized to increase the internal pressure of the battery case 11. This will avoid a situation in which the non-aqueous electrolyte solution 18 having low-concentration support salt is forced out of the electrode body 15. Thus, the concentration of the support salt will not be biased at the middle and the ends of the electrode body 15 with respect to the widthwise direction W. As a result, increases in the DC internal resistance of the electrode body 15 will be limited, and performance deterioration of the lithium-ion rechargeable battery 10, for example, deterioration of the high rate characteristics, will be limited.

In addition, the amount of the remaining organic solvent is greater in the second regions R2, or the end regions, of the positive electrode mixture layer 32 than the first region R1, or middle region, of the positive electrode mixture layer 32. Thus, the amount of organic solvent that vaporizes when charging the lithium-ion rechargeable battery 10 is greater in the second regions R2 than the first region R1. As a result, the bubbles formed when the organic solvent vaporizes during charging of the lithium-ion rechargeable battery 10 do not remain in the electrode body 15 and are readily discharged out of the electrode body 15 from the ends of the electrode body 15.

The second regions R2 extend over distance D2 from the two ends of the positive electrode mixture layer 32. Distance D2 is less than or equal to the radius of the bubbles formed when the organic solvent vaporizes. Thus, the bubbles formed when the organic solvent in the positive electrode plate 30 vaporizes are readily discharged out of the electrode body 15 from the ends of the electrode body 15 and do not remain in the electrode body 15.

### Advantages of Present Embodiment

The advantages of the present embodiment will now be described.

(1) With the lithium-ion rechargeable battery 10 of the present embodiment, the positive electrode mixture layer 32 is formed by drying the positive electrode mixture paste 34, including at least positive electrode active material and organic solvent, so that the organic solvent remains in the positive electrode mixture layer 32. Further, charging is performed, in a state in which the electrode body 15 and the non-aqueous electrolyte solution 18 are accommodated in the battery case 11, to vaporize the organic solvent remaining in the positive electrode mixture layer 32. In this manner, the positive electrode mixture paste 34 is dried to intentionally leave the organic solvent. This allows the organic solvent remaining in the positive electrode mixture layer 32 to vaporize in the battery case 11 during charging. Thus, the internal pressure of the battery case 11 can be increased. This will avoid a situation in which the non-aqueous electrolyte solution 18 in the electrode body 15 is forced out of the electrode body 15. As a result, high rate deterioration of the lithium-ion rechargeable battery 10, caused by high DC internal resistance in the electrode body 15, will be limited.

(2) Charging is performed in a state in which the electrode body 15 and the non-aqueous electrolyte solution 18 are accommodated in the battery case 11. Thus, more organic solvent is vaporized in the second regions R2, or the end regions of the positive electrode mixture layer 32 with respect to the widthwise direction W than the first region R1, or the middle region, of the positive electrode mixture layer 32 with respect to the widthwise direction W. Vaporization of the organic solvent forms less bubbles in the first region R1 than the second regions R2. Thus, the bubbles that remain in the electrode body 15 are limited. This avoids a situation in which the positive electrode plate 30 and the negative electrode plate 20 become overly distanced from each other due to remaining bubbles, which are formed when the organic solvent vaporizes. As a result, performance deterioration of the lithium-ion rechargeable battery 10 is limited.

(3) The second regions R2, which is where the bubbles are readily formed when the organic solvent is vaporized, are separated from the ends of the positive electrode mixture layer 32 in the widthwise direction W, by distance D2. Thus, the bubbles formed when the organic solvent in the second region R2 vaporize are readily discharged out of the electrode body 15 and do not remain in the electrode body 15. This avoids a situation in which the positive electrode plate 30 and the negative electrode plate 20 become overly distanced from each other due to remaining bubbles, which are formed when the organic solvent vaporizes. As a result, performance deterioration of the lithium-ion rechargeable battery 10 is limited.

(4) The positive electrode mixture layer 32 is formed so that the average amount of the organic solvent remaining in the positive electrode mixture layer 32 is less than or equal to a predetermined value in the first region R1 and the second regions R2. In this manner, organic solvent is intentionally left in the positive electrode mixture layer, without the remaining organic solvent being in excess. Since the remaining organic solvent is not excessive, chemical reactions that would be caused by excessively remaining organic solvent and the positive electrode substrate 31 do not occur. As a result, performance deterioration of the lithium-ion rechargeable battery 10 is limited.

### Modified Examples

The above embodiment may be modified as described below. The above embodiment and the following modifications can be combined as long as there is no technical contradiction.

In the above embodiment, the drying nozzles 52 may have any size as long as the second regions R2 and the first regions R1 can be appropriately allocated to the positive electrode mixture paste 34.

In the present embodiment, the drying of the organic solvent does not have to be performed by blowing hot air. For example, the organic solvent may be dried naturally, dried by blowing low-humidity air, dried in a vacuum environment, dried by infrared or ultraviolet light, or dried by a combination of such processes.

In the present embodiment, the negative electrode plate 20 may be manufactured in, for example, the same manner as the positive electrode plate 30. More specifically, a negative electrode mixture paste, which contains at least a negative electrode active material and an organic solvent, may be dried to form the negative electrode mixture layer 22 so that the organic solvent remains in the negative electrode mixture layer 22. In this manner, the present invention may be applied to an electrode plate for a non-aqueous rechargeable battery. The electrode plate includes an electrode substrate and a mixture layer arranged on the electrode substrate. In the non-aqueous rechargeable battery electrode plate, a mixture paste, containing at least an active material and an organic solvent, is dried to form the mixture layer so that the organic solvent remains in the mixture layer.

The present invention is applied to the lithium-ion rechargeable battery 10 in the above embodiment but may be applied to a different type of a rechargeable battery.

In the above embodiment, the lithium-ion rechargeable battery 10, which has the form of a thin plate, is mounted on a vehicle. Instead, the present invention may be applied to a cylindrical battery applied to a marine vessel or an aircraft. Alternatively, the present invention may be applied to a stationary battery.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A non-aqueous rechargeable battery, comprising:
an electrode body including a negative electrode plate, a positive electrode plate, and a separator arranged between the negative electrode plate and the positive electrode plate;
a non-aqueous electrolyte solution; and
a battery case accommodating the electrode body and the non-aqueous electrolyte solution, wherein:
the positive electrode plate includes a positive electrode substrate and a positive electrode mixture layer arranged on the positive electrode substrate;
the positive electrode mixture layer is formed by applying a positive electrode mixture paste, containing at least a positive electrode active material and an organic solvent, to the positive electrode substrate and drying the positive electrode mixture paste so that the organic solvent remains in the positive electrode mixture layer; and
the non-aqueous rechargeable battery is charged in a state in which the electrode body and the non-aqueous electrolyte solution are accommodated in the battery case.

2. The non-aqueous rechargeable battery according to claim 1, wherein:
in a state in which the positive electrode plate, the negative electrode plate, and the separator are stacked in a stacking direction, the electrode body is rolled in a longitudinal direction intersecting the stacking direction; and
the positive electrode mixture layer is formed so that a larger amount of the organic solvent remains in an end region with respect to a widthwise direction, intersecting the stacking direction and the longitudinal direction, than in a middle region with respect to the widthwise direction.

3. The non-aqueous rechargeable battery according to claim 2, wherein:
when the non-aqueous rechargeable battery is charged, the organic solvent vaporizes and forms bubbles; and
the end region is separated from an end of the positive electrode mixture layer in the widthwise direction by a distance that is less than or equal to a radius of the bubbles.

4. The non-aqueous rechargeable battery according to claim 1, wherein the organic solvent is N-methylpyrrolidone.

5. An electrode plate for a non-aqueous rechargeable battery, the electrode plate comprising:
an electrode substrate; and
a mixture layer arranged on the electrode substrate, wherein the mixture layer is formed by applying a mixture paste, containing at least an active material and an organic solvent, to the electrode substrate and drying the mixture paste so that the organic solvent remains in the mixture layer.

6. The electrode plate according to claim 5, wherein the mixture layer is formed so that a larger amount of the organic solvent remains in an end region with respect to a widthwise direction than in a middle region with respect to the widthwise direction.

7. A method for manufacturing a non-aqueous rechargeable battery, the non-aqueous rechargeable battery including an electrode body, a non-aqueous electrolyte solution, and a battery case accommodating the electrode body and the non-aqueous electrolyte solution, the electrode body including a negative electrode plate, a positive electrode plate, and a separator arranged between the negative electrode plate and the positive electrode plate, the method comprising:
applying a positive electrode mixture paste, containing at least a positive electrode active material and an organic solvent, to a positive electrode substrate;
forming a positive electrode mixture layer by drying the positive electrode mixture paste so that the organic solvent remains in the positive electrode mixture layer; and
charging the non-aqueous rechargeable battery in a state in which the electrode body and the non-aqueous electrolyte solution are accommodated in the battery case.

8. The method according to claim 7, wherein:
in a state in which the positive electrode plate, the negative electrode plate, and the separator are stacked in a stacking direction, the electrode body is rolled in a longitudinal direction intersecting the stacking direction; and
the forming a positive electrode mixture layer includes forming the positive electrode mixture layer so that a larger amount of the organic solvent remains in an end region with respect to a widthwise direction, intersecting the stacking direction and the longitudinal direction, than in a middle region with respect to the widthwise direction.

9. The method according to claim 8, wherein:
when the non-aqueous rechargeable battery is charged, the organic solvent vaporizes and forms bubbles; and
the end region is separated from an end of the positive electrode mixture layer in the widthwise direction by a distance that is less than or equal to a radius of the bubbles.

10. The method according to claim 7, wherein the organic solvent is N-methylpyrrolidone.
